(19) United States
(12) Patent Application Publication
(10) Pub. No.: US 2020/0315336 A1
(43) Pub. Date: Oct. 8, 2020

(54) TRANSMISSION DEVICE AND FACE CLEANING INSTRUMENT

(71) Applicant: TOUCHBEAUTY BEAUTY & HEALTH (SHENZHEN) CO., LTD., Shenzhen (CN)

(72) Inventor: Elin ZHOU, Shenzhen (CN)

(73) Assignee: TOUCHBEAUTY BEAUTY & HEALTH (SHENZHEN) CO., LTD.

(21) Appl. No.: 16/910,123

(22) Filed: Jun. 24, 2020

Related U.S. Application Data
(63) Continuation-in-part of application No. PCT/CN2017/119824, filed on Dec. 29, 2017.

(51) Int. Cl. A46B 13/02; F16H 37/12; A46B 15/00

(52) U.S. Cl. CPC A46B 13/023; A46B 2200/1006; A46B 15/0004; F16H 37/12

(57) ABSTRACT

A transmission device and a face cleaning instrument, the transmission device includes an output shaft; an output mechanism connected with the output shaft; a first drive mechanism; a rotation transmission mechanism connected with the first drive mechanism and configured to convert kinetic energy output by the first drive mechanism into rotation motion to be transmitted to the output mechanism; a slewing transmission mechanism connected with the first drive mechanism and configured to convert kinetic energy output by the first drive mechanism into slewing and vibration to be transmitted to the output mechanism; and a second drive mechanism. The same cleaning brush is enabled to switch between the rotation motion and the slewing and vibration freely according to actual requirement is implemented.

### TECHNICAL FIELD

The present disclosure relates to the technical field of face cleaning instrument, and particularly to a transmission device and a face cleaning instrument using the transmission device.

### BACKGROUND

The existing face cleaning instrument generally achieves a cleaning effect by the two methods of driving a face cleaning brush to rotate or driving a face cleaning brush to perform slewing and vibration; however, the existing face cleaning instrument usually has only one single function of rotation or has only one single function of slewing and vibration, although there are some face cleaning instruments which have the function of rotation and the function of slewing and vibration simultaneously, the function of rotation and the function of slewing and vibration may only be implemented by replacing a brush head; thus, it is very inconvenient to use these face cleaning instruments.

### Technical Problem

An objective of the present disclosure is providing a transmission device and a face cleaning instrument, which aim at solving a technical problem in the existing face cleaning instrument that the same face cleaning instrument may not achieve the function of rotation and the function of slewing and vibration at the same time.

### Technical Solution

In order to achieve the objective mentioned above, a technical solution adopted by the present disclosure is providing a transmission device, including:

an output shaft;

an output mechanism connected with the output shaft and configured to drive the output shaft to perform rotation motion or slewing and vibration;

a first drive mechanism;

a rotation transmission mechanism connected with the first drive mechanism and configured to convert kinetic energy output by the first drive mechanism into the rotation motion to be transmitted to the output mechanism;

a slewing transmission mechanism connected with the first drive mechanism and configured to convert kinetic energy output by the first drive mechanism into the slewing and vibration to be transmitted to the output mechanism; and

a second drive mechanism configured to enable the output mechanism to be connected with the rotation transmission mechanism and to be separated from the slewing transmission mechanism, or enable the output mechanism to be connected with the slewing transmission mechanism and to be separated from the rotation transmission mechanism by switching.

Furthermore, the output shaft is provided with a first gear, the output mechanism includes a first shaft, a second gear configured to be connected with the rotation transmission mechanism, and a third gear configured to be connected with the slewing transmission mechanism and drive the second gear to rotate, both the second gear and the third gear are sleeved on the first shaft, and the first gear and the second gear are meshed with each other;

the second drive mechanism includes a switching element configured to drive the second gear and the third gear to perform a reciprocating motion in an axial direction of the first gear to enable the third gear to be connected with the slewing transmission mechanism and cause the second gear to be separated from the rotation drive mechanism, or to cause the third gear to be separated from the slewing drive mechanism and enable the second gear to be connected with the rotation drive mechanism.

Furthermore, the second gear and the third gear are two segments in an axial direction of the same gear.

Furthermore, the second gear has a diameter larger than a diameter of the third gear.

Furthermore, the rotation transmission mechanism includes a driving gear mounted on the first drive mechanism and a driven gear set configured to be connected with the second gear, and the driving gear is meshed with the driven gear set.

Furthermore, the switching element is an electromagnetic switching element which comprises an electromagnetic core configured to drive the second gear and the third gear to move and an electromagnetic coil configured to drive the electromagnetic core to move, and the electromagnetic core is connected with the second gear.

Furthermore, the electromagnetic core and the first shaft are integrally formed from the same material.

Furthermore, the second drive mechanism further includes a box body, the electromagnetic core is a magnetic guide rod, the box body has a cavity, the guide rod penetrates through the cavity, and one end of the guide rod extends beyond the cavity and is connected with the second gear, the electromagnetic coil is sleeved on the guide rod, and the electromagnetic coil is arranged in the cavity.

Furthermore, the second drive mechanism further includes a first returning elastic element configured to drive the second gear and the third gear to return to their initial positions, the first returning elastic element is sleeved on the first shaft, one end of the first returning elastic element is fixedly connected with the first shaft, and the other end of the first returning elastic element abuts against the third gear.

Furthermore, the second drive mechanism further includes a second returning elastic element configured to drive the guide rod to return to its initial position, the second returning elastic element is sleeved on one end of the guide rod away from the second gear, one end of the second returning elastic element is fixedly connected with the guide rod, and the other end of the second returning elastic element abuts against the box body.

Furthermore, the slewing transmission mechanism includes a second shaft, a slewing connecting rod that may swing around the second shaft, and an eccentric element configured to drive the slewing connecting rod to swing around the second shaft, a fixing hole is disposed on the slewing connecting rod, the second shaft is fixed in the fixing hole, a movable groove is arranged on the slewing connecting rod, the eccentric element is arranged in the movable groove and is connected with the first drive mechanism, and the slewing connecting rod is provided with teeth configured to be connected with the third gear.

Furthermore, the teeth are arranged at one end of the slewing connecting rod away from the movable groove.

Furthermore, a wear-resistant sleeve is sleeved on the eccentric element.

Furthermore, the transmission device further includes a housing which has an accommodation chamber, one end of the output shaft is exposed of the housing, the output mechanism, the first drive mechanism, the rotation transmission mechanism, the slewing transmission mechanism and the second drive mechanism are fixed in the accommodation chamber.

The present disclosure further provides a face cleaning instrument, including a face cleaning brush, where the face cleaning instrument further includes the transmission device as described above, and the face cleaning brush is arranged on the output shaft.

### Advantageous Effects

The advantageous effects of the transmission device and the face cleaning instrument provided by the present disclosure are reflected in that: as compared to the prior art, in the transmission device provided by the present disclosure, the kinetic energy output by the first drive mechanism is converted into rotation motion to be transmitted to the output mechanism by means of the rotation transmission mechanism, the kinetic energy output by the first drive mechanism is converted into stewing and vibration to be transmitted to the output mechanism by means of the slewing transmission mechanism, and the second drive mechanism may switch between the mode that the output mechanism is connected with the rotation transmission mechanism and is separated from the sewing transmission mechanism and the mode that the output mechanism is connected with the slewing transmission mechanism and is separated from the rotation transmission mechanism freely. When the output mechanism is connected with the rotation transmission mechanism and the output mechanism is separated from the slewing transmission mechanism, the rotation transmission mechanism drives the output shaft to perform rotation motion by means of the output mechanism. When the output mechanism is connected with the stewing transmission mechanism and the output mechanism is separated from the rotation transmission mechanism, the stewing transmission mechanism drives the output shaft to perform slewing and vibration by means of the output mechanism. In this way, the same face cleaning brush is enabled to switch between the rotation motion and the slewing and vibration freely according to an actual requirement, and the technical problem that the existing face cleaning instrument may not realize the function of rotation and the function of slewing and vibration simultaneously without replacing the face cleaning brush is effectively solved, the transmission device is simple in structure and is convenient and fast to use.

### BRIEF DESCRIPTION OF THE DRAWINGS

In order to explain the embodiments of the present disclosure more clearly, a brief introduction regarding the accompanying drawings that need to be used for describing the embodiments of the present disclosure or the prior art is given below; it is apparent that the accompanying drawings described as follows are merely some embodiments of the present disclosure, the person of ordinary skill in the art may also acquire other drawings according to the current drawings on the premise of paying no creative labor.

FIG. 1 illustrates a schematic diagram of stereoscopic structure of a transmission device provided by the first embodiment of the present disclosure;

FIG. 2 illustrates a schematic diagram of an assembly structure of the transmission device provided by the first embodiment of the present disclosure;

FIG. 3 illustrates a partially enlarged schematic diagram of the transmission device provided by the first embodiment of the present disclosure;

FIG. 4 illustrates a schematic structural diagram of the transmission device in FIG. 3 which is seen from a different angle;

FIG. 5 illustrates a schematic diagram of stereoscopic structure of a slewing connecting rod used in the first embodiment of the present disclosure;

FIG. 6 illustrates a schematic diagram of stereoscopic structure of an eccentric element used in the first embodiment of the present disclosure;

FIG. 7 illustrates a schematic diagram of stereoscopic structure of a transmission device provided by the second embodiment of the present disclosure;

FIG. 8 illustrates a schematic diagram of an assembly structure of the transmission device provided by the second embodiment of the present disclosure;

FIG. 9 illustrates a partially enlarged schematic diagram of the transmission device provided by the second embodiment of the present disclosure;

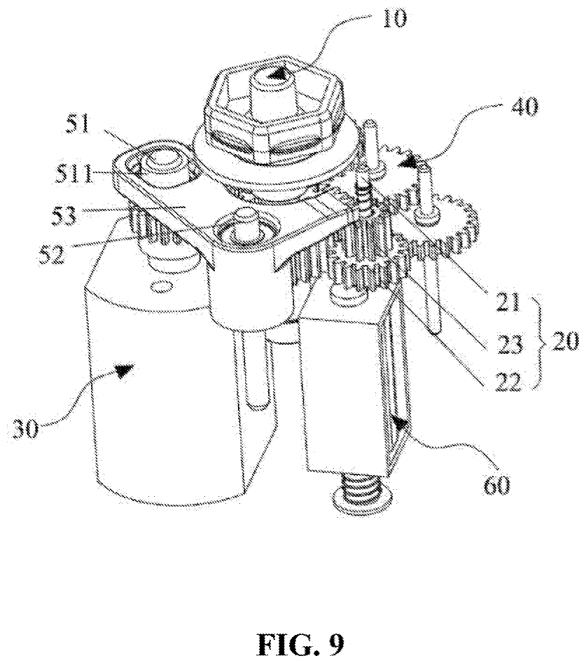

FIG. 10 illustrates a schematic structural diagram of the transmission device shown in FIG. 9, which is seen from a different angle;

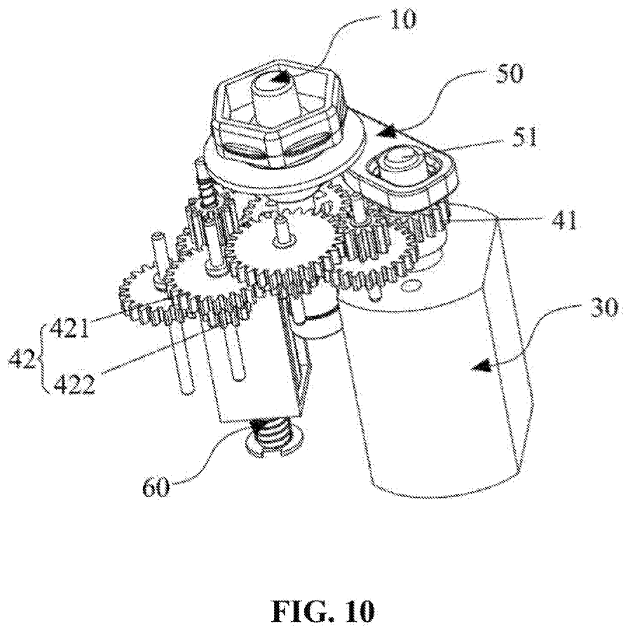

FIG. 11 illustrates a stereoscopic schematic structural diagram of a slewing connecting rod used in the second embodiment of the present disclosure;

FIG. 12 illustrates a top view of a stereoscopic structure of a second drive mechanism used in the second embodiment of the present disclosure; and

FIG. 13 illustrates a cross-sectional schematic diagram along a line A-A in FIG. 12.

Wherein, reference numerals in the accompanying figures are listed as follows:

10—output shaft; 11—the first gear; 20—output mechanism; 21—the first shaft; 22—the second gear; 23—the third gear; 24—concaved cavity; 30—the first drive mechanism; 40—the rotation transmission mechanism; 41—driving gear; 42—driven gear set; 421—the first driven gear; 422—the second driven gear; 50—slewing transmission mechanism; 51—eccentric element; 511—wear-resistant sleeve; 52—the second shaft; 53—slewing connecting rod; 531—fixing hole; 532—movable groove; 54—movable part; 55—connecting part; 56—extended part; 60—the second drive mechanism; 61—electromagnetic coil; 62—box body; 63—guide rod; 64—the first returning elastic element; 65—the second returning elastic element; 70—housing; 701—accommodation chamber; 71—upper housing; 72—lower housing; 80—outer cover.

### DESCRIPTION OF THE EMBODIMENTS

In order to make the purpose, the technical solution and the advantageous effects of the present disclosure be clearer and more understandable, the present disclosure will be further described in detail below with reference to accompanying figures and embodiments. It should be understood that the specific embodiments described herein are merely intended to illustrate but not to limit the present disclosure.

It needs to be noted that, when one component is described to be “fixed to” or “arranged on” another component, this component may be directly or indirectly arranged on another component. When one component is described to be “connected with” another component, it may be directly or indirectly connected with the other component.

It needs to be understood that, directions or location relationships indicated by terms such as “length”, “width”, “up”, “down”, “front”, “rear”, “left”, “right”, “vertical”, “horizontal”, “top”, “bottom”, “inside”, “outside”, and so on are the directions or location relationships shown in the accompanying figures, which are only intended to describe the present disclosure conveniently and simplify the description, but not to indicate or imply that an indicated device or component must have specific locations or be constructed and manipulated according to specific locations; therefore, these terms shouldn't be considered as any limitation to the present disclosure.

In addition, terms of “the first” and “the second” are only used for describing purposes, and should not be considered as indicating or implying any relative importance, or impliedly indicating the number of indicated technical features. As such, technical feature(s) restricted by “the first” or “the second” can explicitly or impliedly comprise one or more such technical feature(s). In the description of the present disclosure, “a plurality of” has the meaning of at least two, unless there is additional explicit and specific limitation.

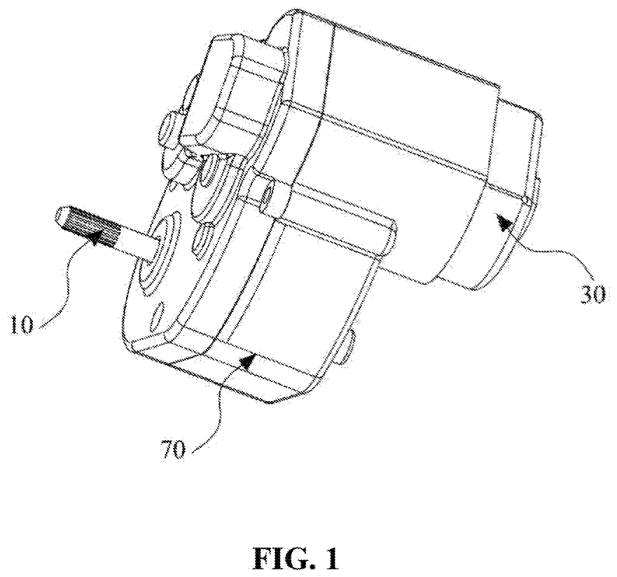

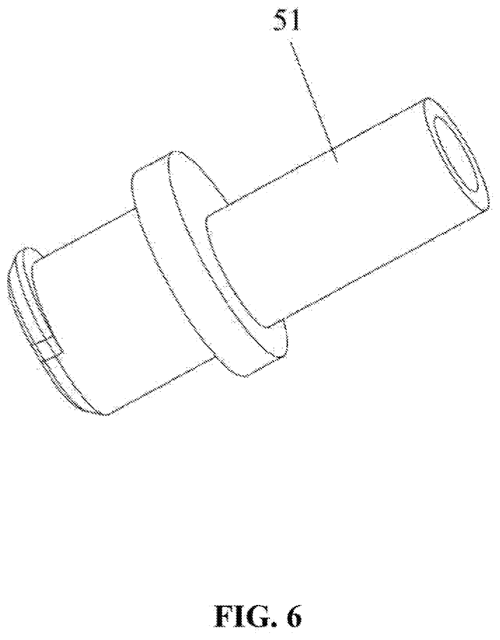

Referring to FIG. 1 and FIG. 6, the transmission device provided by the present disclosure is currently described. As the first specific implementation of the present disclosure, the aforesaid transmission device includes: an output shaft 10; an output mechanism 20 connected with the output shaft 10 and configured to drive the output shaft 10 to perform rotation motion or slewing and vibration; a first drive mechanism 30; a rotation transmission mechanism 40 connected with the first drive mechanism 30 and configured to convert kinetic energy output by the first drive mechanism 30 into rotation motion to be transmitted to the output mechanism 20; a slewing transmission mechanism 50 connected with the first drive mechanism 30 and configured to convert kinetic energy output by the first drive mechanism 30 into slewing and vibration to be transmitted to the output mechanism 20; and a second drive mechanism 60 configured to enable the output mechanism 20 to be connected with the rotation transmission mechanism 40 and to be separated from the slewing transmission mechanism 50, or enable the output mechanism 20 to be connected with the slewing transmission mechanism 50 and to be separated from the rotation drive mechanism 40 by switching. Where, in this embodiment, when the output mechanism 20 ascends, the output mechanism 20 is connected with the slewing transmission mechanism 50 and is separated from the rotation transmission mechanism 40. When the output mechanism 20 descends, the output mechanism 20 is connected with the rotation transmission mechanism 40 and is separated from the slewing transmission mechanism 50.

Comparing the transmission device provided by the present disclosure with the prior art, the kinetic energy output by the first drive mechanism 30 is converted into the rotation motion to be transmitted to the output mechanism 20 by means of the rotation transmission mechanism 40, the kinetic energy output by the first drive mechanism 30 is converted into slewing and vibration to be transmitted to the output mechanism 20 by means of the slewing transmission mechanism 50; moreover, the second drive mechanism 60 may freely switch between the mode that the output mechanism 20 is connected with the rotation transmission mechanism 40 and is separated from the stewing transmission mechanism 50 and the mode that the output mechanism 20 is connected with the slewing transmission mechanism 50 and is separated from the rotation transmission mechanism 40. When the output mechanism 20 is connected with the rotation transmission mechanism 40 and is separated from the sewing transmission mechanism 50, the rotation transmission mechanism 40 drives the output shaft 10 to rotate by means of the output mechanism 20; when the output mechanism 20 is connected with the slewing transmission mechanism 50 and is separated from the rotation transmission mechanism 40, the slewing transmission mechanism 50 drives the output shaft 10 to perform stewing and vibration by means of the output mechanism 20, in this way, the same face cleaning brush may be enabled to switch between the rotation motion and the sewing and vibration freely according to actual requirement, and the technical problem that the existing face cleaning instrument may not realize the function of rotation and the function of slewing and vibration simultaneously without replacing face cleaning brush is effectively solved, the transmission device is simple in structure and is convenient and fast to use.

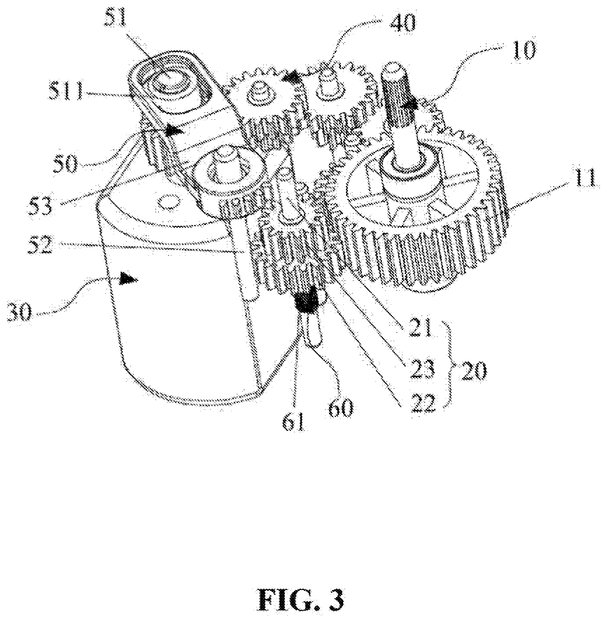

Further, as shown in FIG. 3, a first gear 11 is arranged on the output shaft 10, the output mechanism 20 includes a first shaft 21, a second gear 22 configured to be connected with the rotation transmission mechanism 40, and a third gear 23 configured to be connected with the stewing transmission mechanism 50 and drive the second gear 22 to rotate, both the second gear 22 and the third gear 23 are sleeved on the first shaft 21, and the first gear 11 and the second gear 22 are meshed with each other. The second drive mechanism 60 includes a switching component configured to push the second gear 22 and the third gear 23 to perform reciprocating motion along the axial direction of the first gear 11 so as to enable the third gear 23 to be connected with the slewing transmission mechanism 50 and to cause the second gear 22 to be separated from the rotation transmission mechanism 40, or cause the third gear 23 to be separated from the sewing transmission mechanism 50 and enable the second gear 22 to be connected with the rotation transmission mechanism 40. When the output mechanism 20 ascends, the third gear 23 is connected with the slewing transmission mechanism 50 and the second gear 22 is separated from the rotation transmission mechanism 40, the second gear 22 is always meshed with the first gear 11, so that the slewing transmission mechanism 50 is enabled to convert the kinetic energy output by the first drive mechanism 30 into slewing and vibration to be transmitted to the output shaft 10. When the output mechanism 20 descends, the third gear 23 is separated from the slewing transmission mechanism 50 and the second gear 22 is connected with the rotation transmission mechanism 40, so that the rotation transmission mechanism 40 is enabled to convert the kinetic energy output by the first drive mechanism 30 into the rotation motion to be transmitted to the output shaft 10.

In this embodiment, the second gear 22 and the third gear 23 are preferably two independently arranged gears, and the diameter of the second gear 22 is larger than the diameter of the third gear 23. It should be noted that, the arrangement of the second gear 22 and the third gear 23 is not limited thereto, for example, in other preferable embodiments of the present disclosure, the second gear 22 and the third gear 23 may also be two segments in the axial direction of the same gear, that is, the second gear 22 and the third gear 23 are integrally formed.

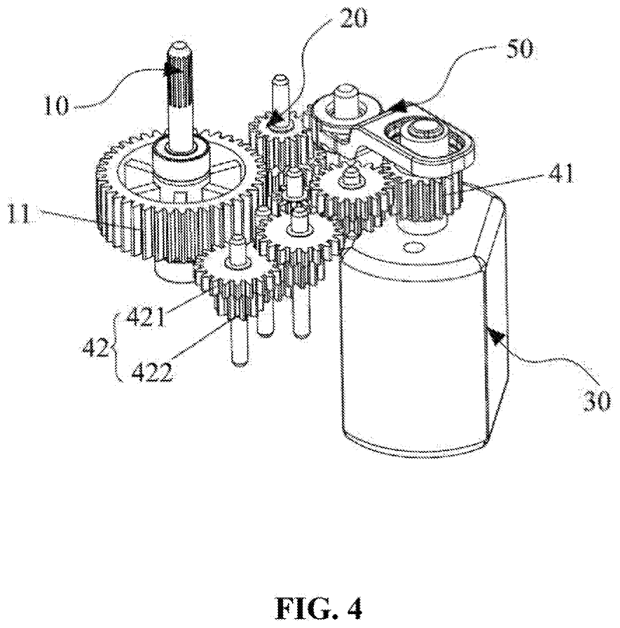

Furthermore, as shown in FIG. 3 and FIG. 4, the rotation transmission mechanism 40 includes a driving gear 41 mounted on the first drive mechanism 30 and a driven gear set 42 configured to be connected with the second gear, and the driving gear 41 is meshed with the driven gear set 42. The first drive mechanism 30 drives the driving gear 41 to rotate so as to drive the driven gear set 42 to rotate. In this embodiment, there are multiple driven gear sets 42, and each driven gear set 42 includes a first driven gear 421 and a second driven gear 422 which are coaxially arranged. It should be noted that, the number of driven gear sets 42 may also be set according to the actual requirement, for example, the number of driven gear sets 42 may be set to be three, four, or more. The diameters of the first driven gear 421 and the second driven gear 422 which are coaxially arranged may be the same or different, and the numbers of the first driven gear 421 and the second driven gear 422 may also be set according to the actual requirement, which are not limited herein. The first drive mechanism 30 may be a motor or a hydraulic motor or other drive mechanism that is capable of generating rotation, as an alternative, the first drive mechanism 30 may also be a drive mechanism such as a push rod, a cylinder and the like which is capable of generating linear motion, the linear motion is then converted into the rotation motion, for example, the linear motion is converted into the rotation motion by means of a gear rack and the like.

Furthermore, as shown in FIG. 3, the switching component is an electromagnetic switching component which includes an electromagnetic core configured to drive the second gear 22 and the third gear 23 to move, and an electromagnetic coil 61 configured to drive the electromagnetic core to move, the electromagnetic core is connected with the second gear 22. In this embodiment, the electromagnetic core and the first shaft 21 are integrally formed from the same material, that is, the first shaft 21 is made of the material as same as that of the electromagnetic core, so that the first shaft 21 has the function of electromagnetic core. Of course, the second gear 22 and the third gear 23 may also be driven to perform reciprocating motion by arranging the electromagnetic core on the first shaft 21. When being energized, the electromagnetic coil 61 generates magnetic force which causes the first shaft 21 to ascend, when the electromagnetic coil 61 is de-energized, the magnetic force of the electromagnetic coil 61 disappears, so that the first shaft 21 returns to its initial position.

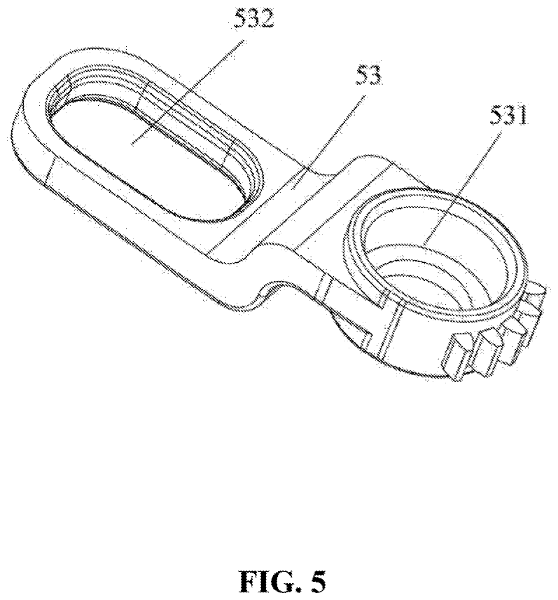

Furthermore, as shown in FIG. 3, FIG. 4, FIG. 5, and FIG. 6, the slewing transmission mechanism 50 includes a second shaft 52, a slewing connecting rod 53 which may swing around the second shaft 52 and an eccentric element 51 configured to drive the slewing connecting rod 53 to swing around the second shaft 52, a fixing hole 531 is arranged on the slewing connecting rod 53, the second shaft 52 is fixed in the fixing hole 531. A movable groove 532 is arranged in the slewing connecting rod 53. The eccentric element 51 is arranged in the movable groove 532 and the eccentric element 51 is connected with the first drive mechanism 30, and teeth are arranged on the slewing connecting rod 53 and are configured to be connected to the third gear 23. Furthermore, in this embodiment, the teeth are arranged on the end of the slewing connecting rod 53 away from the movable groove 532. It should be noted that, the arrangement of positions of the teeth are not limited thereto, in other preferable embodiments of the present disclosure, the teeth may also be arranged in other positions according to the actual requirement. The first drive mechanism 30 drives the eccentric element 51 to rotate so as to enable the eccentric element 51 to collide with the slewing connecting rod 53, due to the fact that the slewing connecting rod 53 may generate a periodic slewing movement under the driving of the eccentric element 51, and a vibration effect may be generated due to high frequent collision between the eccentric element 51 and the slewing connecting rod 53, the effect of slewing and vibration is finally achieved accordingly.

Furthermore, the second shaft 52 is connected with the slewing connecting rod 53 through a bearing, such that the slewing connecting rod 53 may rotate around the second shaft 52. In this embodiment, the slewing connecting rod 53 is shaped as a strip preferably. The movable groove 532 is arranged at one end of the slewing connecting rod 53, the fixing hole 531 is arranged on the other end of the slewing connecting rod 53. It should be noted that, the shape of the slewing connecting rod 53 is not limited thereto, in other preferable embodiments of the present disclosure, the slewing connecting rod 53 may be in other shape.

Furthermore, an axis of rotation of the eccentric element 51 is spaced from an axis of rotation of the first drive mechanism 30, that is, the axis of rotation of the eccentric element 51 and the axis of rotation of the first drive mechanism 30 are non-collinear. In this embodiment, the eccentric element 51 is shaped as a cylinder, and the eccentric element 51 is arranged on the output shaft 10 of the first drive mechanism 30. Preferably, a replaceable wear sleeve 511 is sleeved on the eccentric element 51, such that a service life of the eccentric element 51 may be effectively prolonged.

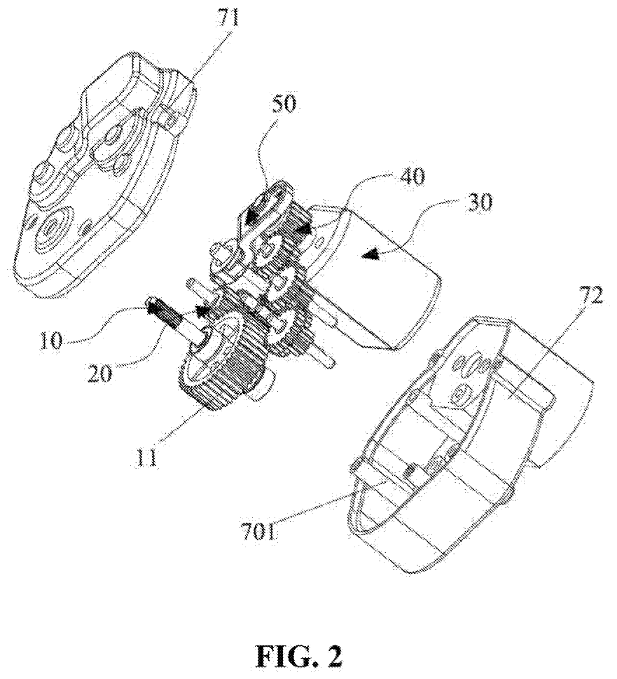

Furthermore, as shown in FIG. 1 and FIG. 2, the transmission device includes a housing 70 which has an accommodation chamber 701, one end of the output shaft 10 is exposed of the housing 70, the output mechanism 20, the first drive mechanism 30, the rotation transmission mechanism 40, the slewing transmission mechanism 50, and the second drive mechanism 60 are fixed in the accommodation chamber 701. Preferably, the housing 70 includes an upper housing 71 and a lower housing 72 connected with the upper housing 70. The upper housing 71 is in butt joint with the lower housing 72, and the upper housing 71 and the lower housing 72 are enclosed so as to form the accommodation chamber 701. The upper housing 70 and the lower housing 70 are fixedly connected by screws, of course, the approaches of fixed connecting the upper housing 70 with the lower housing 70 are not limited thereto, in other preferable embodiments of the present disclosure, the upper housing 70 and the lower housing 70 may also be secured by a snap-fitting method or by other connection method.

A working procedure in this embodiment is described below:

When the output shaft 10 needs to achieve slewing and vibration, firstly, the electromagnetic coil 61 is energized and generates magnetic force, which causes the first shaft 21 to ascend, the third gear 23 is connected with the slewing transmission mechanism 50 and the second gear 22 is separated from the rotation transmission mechanism 40, since the second gear 22 is always meshed with the first gear 11, so that the slewing transmission mechanism 50 is enabled to convert the kinetic energy output by the first drive mechanism 30 into the slewing and vibration to be transmitted to the output shaft 10.

When the output shaft 10 needs to achieve rotation movement, firstly, the electromagnetic coil 61 is de-energized, the magnetic force of the electromagnetic coil 61 disappears, the first shaft 21 descends to its initial position, the third gear 23 is separated from the slewing transmission mechanism 5 and the second gear 22 is connected with the rotation transmission mechanism 40, so that the rotation transmission mechanism 40 is enabled to convert kinetic energy output by the first drive mechanism 30 into rotation motion to be transmitted to the output shaft 10.

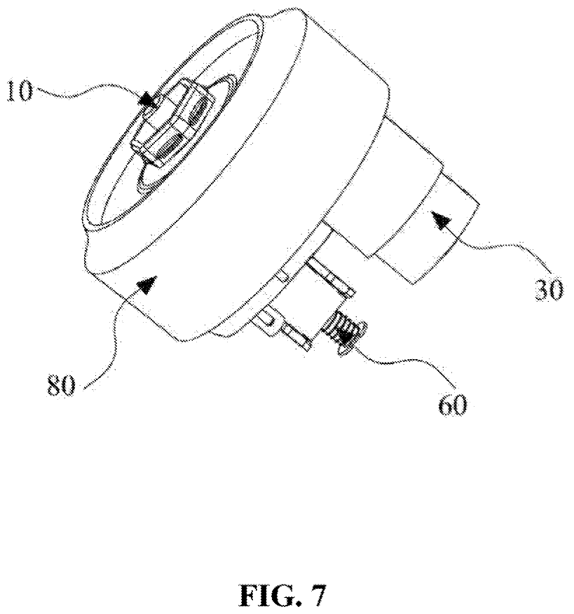

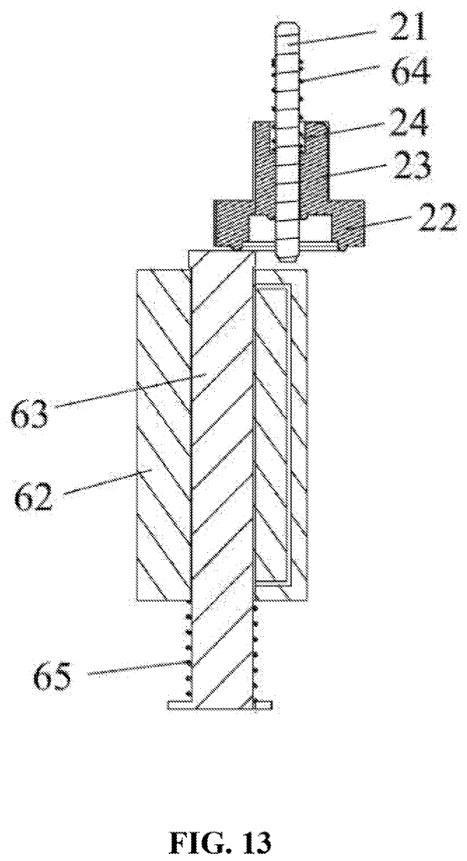

Referring to FIG. 7 and FIG. 13, as a second specific embodiment of the present disclosure, the structure of the transmission device provided by the second embodiment is substantially the same as the structure of the transmission device provided by the first embodiment, the differences are reflected in that:

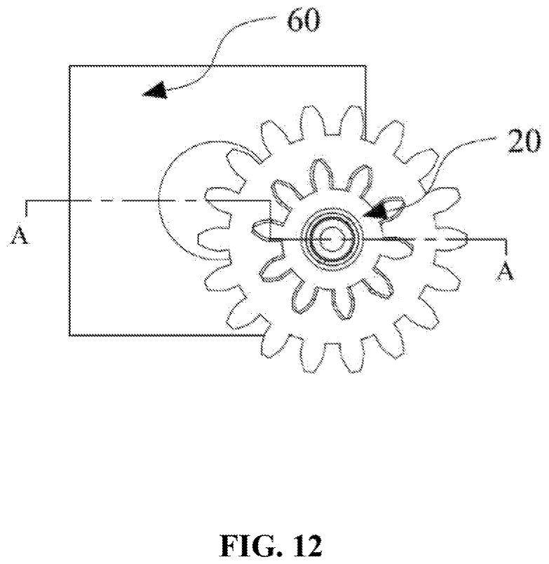

as shown in FIG. 12 and FIG. 13, in this embodiment, the second drive mechanism 60 further includes a box body 62, the electromagnetic core is a magnetic guide rod 63, the box body 62 has a cavity (not shown in the figures), the guide rod 63 penetrates through the cavity, and one end of the guide rod 63 extends beyond the cavity and is connected with the second gear 22, the electromagnetic coil 61 (not shown in the figures) is sleeved on the guide rod 63, and the electromagnetic coil 61 is arranged in the cavity. When being energized, the electromagnetic coil 61 generates magnetic force which drives the guide rod 63 to ascend and further drives the output mechanism 20 to move upwards, the third gear 23 is connected with the slewing transmission mechanism 50 and the second gear 22 is separated from the rotation transmission mechanism 40, so that the slewing transmission mechanism 50 is enabled to drive the output shaft 10 to perform slewing and vibration by means of the output mechanism 20. When being de-energized, the magnetic force of the electromagnetic coil disappears, the guide rod 63 descends to its initial position, the output mechanism 20 moves downwards, the third gear 23 is separated from the slewing transmission mechanism 50 and the second gear 22 is connected with the rotation transmission mechanism 40, so that the rotation transmission mechanism 40 is enabled to drive the output shaft 10 to perform rotation motion by means of the output mechanism 20. It should be noted that, the arrangement of the second drive mechanism 60 is not limited thereto, in other preferable embodiments of the present disclosure, the second drive mechanism 60 may use some other driving approaches, such as driving the first shaft 21 to ascend or descend by means of a linear motor or a cylinder or the like, or driving a gear rack to move by means of rotation of motor, thereby achieving ascending or descending of the first shaft 21 by means of the gear rack.

Furthermore, the second drive mechanism 60 further includes a first returning elastic element 64 configured to drive the second gear 22 and the third gear 23 to return to their initial positions, the first returning elastic element 64 is sleeved on the first shaft 21, one end of the first returning elastic element 64 is fixedly connected with the first shaft 21, and the other end of the first returning elastic element 64 abuts against the third gear 23. Preferably, the third gear 23 has a cavity 24, the first returning elastic element 64 is sleeved on the first shaft 21 and the other end of the first returning elastic element 64 is arranged in the cavity 24. When being energized, the guide rod 63 moves upwards, so that the first returning elastic element 64 is in a compressed state; when being de-energized, the guide rod 63 moves downwards under the action of the first returning elastic element 64. Preferably, the first returning elastic element 64 is a spring.

Furthermore, the second drive mechanism 60 further includes a second returning elastic element 65 configured to drive the guide rod 63 to return to its initial position, and the second returning elastic element 65 is sleeved on one end of the guide rod 63 away from the second gear 22, besides, one end of the second returning elastic element 65 is fixedly connected with the guide rod 63, and the other end of the second returning elastic element 6 abuts against the box body 62. The second returning elastic element 65 is a spring.

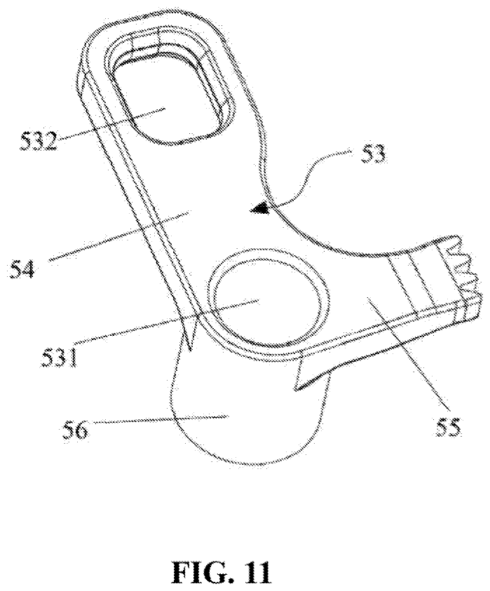

Furthermore, as shown in FIG. 11, the slewing connecting rod 53 is L-shaped. The slewing connecting rod 53 includes a movable part 54 and a connecting part 55 connected with the movable part 54. A junction of the movable part 54 and the connecting part 55 extends downwards, so that an extended part 56 is formed. The extended part 56 is provided with a through hole, the movable groove 532 is concaved on the movable part 54, the fixing hole 531 is arranged at the junction of the movable part 54 and the connecting part 55, and a central axis of the fixing hole 531 is aligned with a central axis of the through hole. The teeth on the slewing connecting rod 53 are arranged on the connecting part 55, which enables the process of slewing and vibration to be more stable.

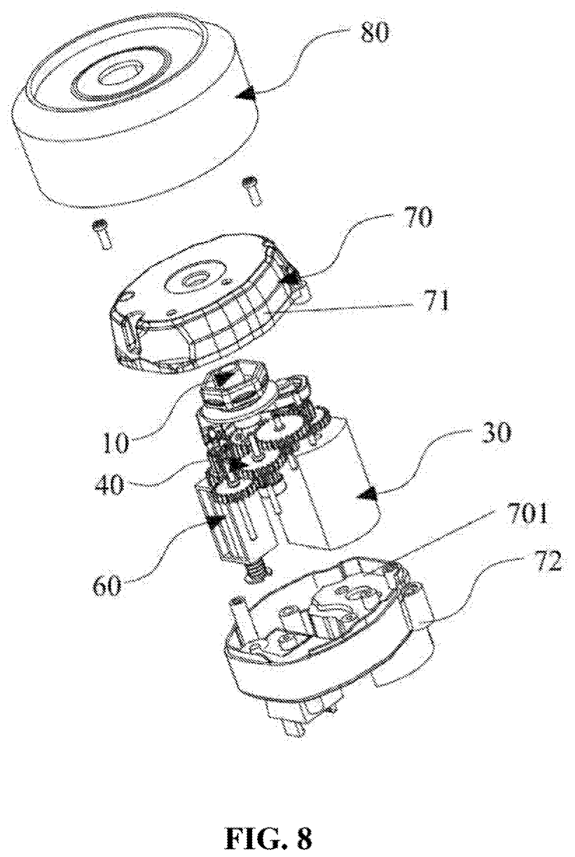

Furthermore, as shown in FIG. 7 and FIG. 8, the transmission device further includes an outer cover 80 which is sleeved on the housing 70. One end of the output shaft 10 extends beyond the outer cover 80.

The present disclosure further provides a face cleaning instrument. The face cleaning instrument includes a face cleaning brush (not shown in the figures). The face cleaning instrument provided by the present disclosure uses the transmission device as described above, the face cleaning brush is arranged on the output shaft 10. The face cleaning brush may switch between the rotation motion and the slewing and vibration according to actual requirement, the face cleaning instrument is simple in structure and is convenient and fast to use.

The foregoing are only preferred embodiments of the present disclosure, and should not be regarded as limitation to the present disclosure. Any modification, equivalent replacement, improvement, and the like, which are made within the spirit and the principle of the present disclosure, should all be included in the protection scope of the present disclosure.

What is claimed is:

1. A transmission device, comprising:
an output shaft;
an output mechanism connected with the output shaft and configured to drive the output shaft to perform rotation motion or slewing and vibration;
a first drive mechanism;
a rotation transmission mechanism connected with the first drive mechanism and configured to convert kinetic energy output by the first drive mechanism into the rotation motion to be transmitted to the output mechanism;
a slewing transmission mechanism connected with the first drive mechanism and configured to convert kinetic energy output by the first drive mechanism into the slewing and vibration to be transmitted to the output mechanism; and
a second drive mechanism configured to enable the output mechanism to be connected with the rotation transmission mechanism and to be separated from the slewing transmission mechanism, or enable the output mechanism to be connected with the sewing transmission mechanism and to be separated from the rotation transmission mechanism by switching.

2. The transmission device according to claim 1, wherein the output shaft is provided with a first gear, the output mechanism comprises a first shaft, a second gear configured to be connected with the rotation transmission mechanism, and a third gear configured to be connected with the stewing transmission mechanism and drive the second gear to rotate, wherein both the second gear and the third gear are sleeved on the first shaft, and the first gear and the second gear are meshed with each other;
the second drive mechanism comprises a switching element configured to drive the second gear and the third gear to perform a reciprocating motion in an axial direction of the first gear to enable the third gear to be connected with the slewing transmission mechanism and cause the second gear to be separated from the rotation drive mechanism, or to cause the third gear to be separated from the slewing drive mechanism and enable the second gear to be connected with the rotation drive mechanism.

3. The transmission device according to claim 2, wherein the second gear and the third gear are two segments in an axial direction of the same gear.

4. The transmission device according to claim 2, wherein the second gear has a diameter larger than a diameter of the third gear.

5. The transmission device according to claim 2, wherein the rotation transmission mechanism comprises a driving gear mounted on the first drive mechanism and a driven gear set configured to be connected with the second gear, and the driving gear is meshed with the driven gear set.

6. The transmission device according to claim 2, wherein the switching element is an electromagnetic switching element which comprises an electromagnetic core configured to drive the second gear and the third gear to move and an electromagnetic coil configured to drive the electromagnetic core to move, and the electromagnetic core is connected with the second gear.

7. The transmission device according to claim 6, wherein the electromagnetic core and the first shaft are integrally formed from the same material.

8. The transmission device according to claim 6, wherein the second drive mechanism further comprises a box body, the electromagnetic core is a magnetic guide rod, the box body has a cavity, the guide rod penetrates through the cavity, and one end of the guide rod extends beyond the cavity and is connected with the second gear, the electromagnetic coil is sleeved on the guide rod, and the electromagnetic coil is arranged in the cavity.

9. The transmission device according to claim 8, wherein the second drive mechanism further comprises a first returning elastic element configured to drive the second gear and the third gear to return to their initial positions, the first returning elastic element is sleeved on the first shaft, one end of the first returning elastic element is fixedly connected with the first shaft, and the other end of the first returning elastic element abuts against the third gear.

10. The transmission device according to claim 8, wherein the second drive mechanism further comprises a second returning elastic element configured to drive the guide rod to return to its initial position, the second returning elastic element is sleeved on one end of the guide rod away from the second gear, one end of the second returning elastic element is fixedly connected with the guide rod, and the other end of the second returning elastic element abuts against the box body.

11. The transmission device according to claim 2, wherein the slewing transmission mechanism comprises a second shaft, a slewing connecting rod that may swing around the second shaft, and an eccentric element configured to drive the slewing connecting rod to swing around the second shaft, a fixing hole is disposed on the slewing connecting rod, the second shaft is fixed in the fixing hole, a movable groove is arranged on the slewing connecting rod, the eccentric element is arranged in the movable groove and is connected with the first drive mechanism, and the slewing connecting rod is provided with teeth configured to be connected with the third gear.

12. The transmission device according to claim 11, wherein the teeth are arranged at one end of the slewing connecting rod away from the movable groove.

13. The transmission device according to claim 11, wherein a wear-resistant sleeve is sleeved on the eccentric element.

14. The transmission device according to claim 1, wherein the transmission device further comprises a housing which has an accommodation chamber, one end of the output shaft is exposed of the housing, and wherein the output mechanism, the first drive mechanism, the rotation transmission mechanism, the slewing transmission mechanism and the second drive mechanism are fixed in the accommodation chamber.

15. A face cleaning instrument, comprising a face cleaning brush, wherein the face cleaning instrument further comprises the transmission device according to claim 1, and the face cleaning brush is arranged on the output shaft.

16. The transmission device according to claim 9, wherein the third gear is provided with a cavity, the first returning elastic element is sleeved on the first shaft and the other end of the first returning elastic element is arranged in the cavity.

17. The transmission device according to claim 11, wherein the slewing connecting rod comprises a movable part and a connecting part connected with the movable part, a junction of the movable part and the connecting part extends downwards to form an extended part, the extended part is provided with a through hole, the movable groove is concaved on the movable part, the fixing hole is arranged at the junction of the movable part and the connecting part, and a central axis of the fixing hole is aligned with a central axis of the through hole.

18. The transmission device according to claim 17, wherein the slewing connecting rod is L-shaped.

19. The transmission device according to claim 11, wherein the slewing connecting rod comprises a movable part and a connecting part connected with the movable part, and the teeth are arranged on the connecting part of the slewing connecting rod.

20. The transmission device according to claim 14, further comprising an outer cover which is sleeved on the housing, and one end of the output shaft extends beyond the outer cover.
